(19) United States
(12) Patent Application Publication
(10) Pub. No.: US 2019/0012470 A1
(43) Pub. Date: Jan. 10, 2019

(54) SYSTEMS AND METHODS FOR DETERMINING VALUES OF CONDITIONS EXPERIENCED BY A USER, AND USING THE VALUES OF THE CONDITIONS TO DETERMINE A VALUE OF A USER PERMISSION TO APPLY TO THE USER

(71) Applicant: Tsunami VR, Inc., Del Mar, CA (US)

(72) Inventors: David ROSS, San Diego, CA (US); Beth BREWER, Escondido, CA (US); Kyle PENDERGRASS, San Diego, CA (US)

(21) Appl. No.: 16/000,842

(22) Filed: Jun. 5, 2018

Related U.S. Application Data
(60) Provisional application No. 62/528,510, filed on Jul. 4, 2017.
(60) Provisional application No. 62/593,058, filed on Nov. 30, 2017.

(51) Int. Cl. G06F 21/60; G06F 21/31; G06F 21/12; G06T 19/00; G06T 15/00

(52) U.S. Cl. CPC G06F 21/604; G06F 21/316; G06F 2221/2141; G06T 19/006; G06T 15/005; G06F 21/121

(57) ABSTRACT

Applying different permissions to different users based on conditions experienced by those users operating a user device, and using the values of the conditions to determine a value of a user permission to apply to the user. In one implementation, systems and methods for determining values of conditions experienced by a user operating a user device, and for using the values of the conditions to determine a value of a user permission to apply to the user: determine a value of a first condition experienced by the user operating the user device, use the value of the first condition experienced by the user to determine a value of a first user permission associated with the value of the first condition that can be applied to the user, and apply the value of the first user permission or another value of the first user permission to the user.

### RELATED APPLICATIONS

This application relates to the following related application(s): U.S. Pat. Appl. No. 62/593,058, filed Nov. 30, 2017, entitled SYSTEMS AND METHODS FOR DETERMINING VALUES OF CONDITIONS EXPERIENCED BY A USER, AND USING THE VALUES OF THE CONDITIONS TO DETERMINE A VALUE OF A USER PERMISSION TO APPLY TO THE USER; and U.S. Pat. Appl. No. 62/528,510, filed Jul. 4, 2017 entitled METHOD AND SYSTEM FOR SUPPORTING A MULTITUDE OF DEVICES WITH DIFFERING CAPABILITIES AND CONNECTIVITY IN VIRTUAL ENVIRONMENTS. The content of each of the related application(s) is hereby incorporated by reference herein in its entirety.

### TECHNICAL FIELD

This disclosure relates to virtual reality (VR), augmented reality (AR), and mixed reality (MR) technologies.

### BRIEF DESCRIPTION OF THE DRAWINGS

FIG. 1A and FIG. 1B depict aspects of a positioning system on which different embodiments are implemented for determining values of conditions experienced by a user, and using the values of the conditions to determine a value of a user permission to apply to the user.

FIG. 2A depicts a process for selecting values of user permissions to apply to a user based on conditions experienced by the user.

FIG. 2B provides examples of values of conditions and associated values of user permissions.

FIG. 2C depicts an illustrative process for determining values of one or more conditions during the process of FIG. 2A.

FIG. 2D depicts an illustrative process for determining one or more values of a user permission during the process of FIG. 2A.

FIG. 3A depicts a plurality of networks where each network has a particular connectivity level value that is used to determine one or more values of one or more user permissions to apply to a user of that network.

FIG. 3B depicts a table of values for connectivity conditions and associated user permission values that can be that apply to the users of FIG. 3A.

FIG. 4A depicts a plurality of users and user devices where each user or user device has a particular set of device capability value(s) that are used to determine one or more values of one or more user permissions to apply to the user or user device.

FIG. 4B depicts a table of values for device capability conditions and associated user permission values that can be applied to the users of FIG. 4A.

FIG. 5 depicts a plurality of users and user devices where each user and user device are on the same network, but different connectivity levels as user permission values apply to different users or user devices based on conditions experience by the different users or user devices.

FIG. 6 depicts changes in condition values that result in application of different user permission values over time.

FIG. 7 depicts different groups of users and user devices where a different user permission value is applied to each group based on different values of conditions experienced by the users or user devices of that group.

FIG. 8 depicts different visual indicators that represent user permission values that apply to a first user, where the different visual indicators are displayed to other users so those users understand permissions that apply to the first user.

FIG. 9A and FIG. 9B collectively depict a communication sequence diagram for a system for supporting a plurality of devices with different capabilities and connectivity.

### DETAILED DESCRIPTION

This disclosure relates to different approaches for determining values of conditions experienced by a user, and using the values of the conditions to determine a value of a user permission to apply to the user.

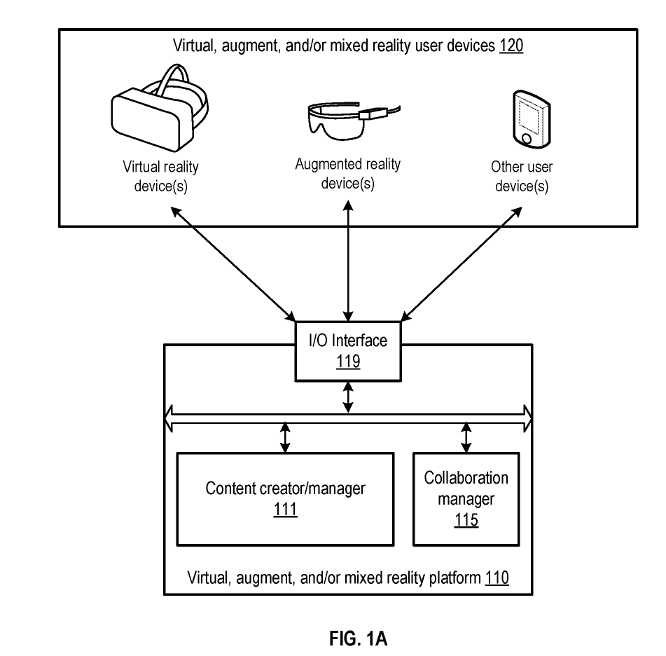

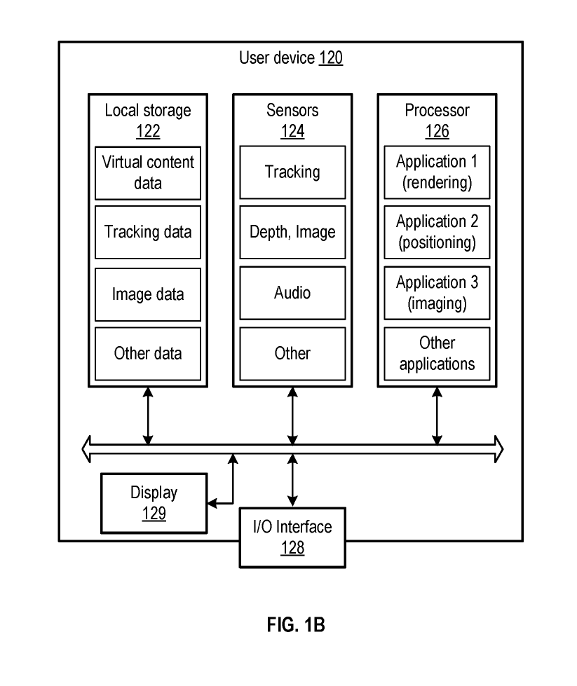

FIG. 1A and FIG. 1B depict aspects of a system on which different embodiments are implemented for determining values of conditions experienced by a user, and using the values of the conditions to determine a value of a user permission to apply to the user. The system includes a virtual, augmented, and/or mixed reality platform 110 (e.g., including one or more servers) that is communicatively coupled to any number of virtual, augmented, and/or mixed reality user devices 120 such that data can be transferred between the platform 110 and each of the user devices 120 as required for implementing the functionality described in this disclosure. General functional details about the platform 110 and the user devices 120 are discussed below before particular functions for determining values of conditions experienced by a user, and using the values of the conditions to determine a value of a user permission to apply to the user are discussed.

As shown in FIG. 1A, the platform 110 includes different architectural features, including a content creator/manager 111, a collaboration manager 115, and an input/output (I/O) interface 119. The content creator/manager 111 creates and stores visual representations of things as virtual content that can be displayed by a user device 120 to appear within a virtual or physical environment. Examples of virtual content include: virtual objects, virtual environments, avatars, video, images, text, audio, or other presentable data. The collaboration manager 115 provides virtual content to different user devices 120, and tracks poses (e.g., positions and orientations) of virtual content and of user devices as is known in the art (e.g., in mappings of environments, or other approaches). The I/O interface 119 sends or receives data between the platform 110 and each of the user devices 120.

Each of the user devices 120 include different architectural features, and may include the features shown in FIG. 1B, including a local storage component 122, sensors 124, processor(s) 126, an input/output (I/O) interface 128, and a display 129. The local storage component 122 stores content received from the platform 110 through the I/O interface 128, as well as information collected by the sensors 124. The sensors 124 may include: inertial sensors that track movement and orientation (e.g., gyros, accelerometers and others known in the art); optical sensors used to track movement and orientation of user gestures; position-location or proximity sensors that track position in a physical environment (e.g., GNSS, WiFi, Bluetooth or NFC chips, or others known in the art); depth sensors; cameras or other image sensors that capture images of the physical environment or user gestures; audio sensors that capture sound (e.g., microphones); and/or other known sensor(s). It is noted that the sensors described herein are for illustration purposes only and the sensors 124 are thus not limited to the ones described. The processor 126 runs different applications needed to display any virtual content within a virtual or physical environment that is in view of a user operating the user device 120, including applications for: rendering virtual content; tracking the pose (e.g., position and orientation) and the field of view of the user device 120 (e.g., in a mapping of the environment if applicable to the user device 120) so as to determine what virtual content is to be rendered on a display (not shown) of the user device 120; capturing images of the environment using image sensors of the user device 120 (if applicable to the user device 120); and other functions. The I/O interface 128 manages transmissions of data between the user device 120 and the platform 110. The display 129 may include, for example, a touchscreen display configured to receive user input via a contact on the touchscreen display, a semi or fully transparent display, or a non-transparent display. In one example, the display 129 includes a screen or monitor configured to display images generated by the processor 126. In another example, the display 129 may be transparent or semi-opaque so that the user can see through the display 129.

Particular applications of the processor 126 may include: a communication application, a display application, and a gesture application. The communication application may be configured to communicate data from the user device 120 to the platform 110 or to receive data from the platform 110, may include modules that may be configured to send images and/or videos captured by a camera of the user device 120 from sensors 124, and may include modules that determine the geographic location and the orientation of the user device 120 (e.g., determined using GNSS, WiFi, Bluetooth, audio tone, light reading, an internal compass, an accelerometer, or other approaches). The display application may generate virtual content in the display 129, which may include a local rendering engine that generates a visualization of the virtual content. The gesture application identifies gestures made by the user (e.g., predefined motions of the user's arms or fingers, or predefined motions of the user device 120 (e.g., tilt, movements in particular directions, or others). Such gestures may be used to define interaction or manipulation of virtual content (e.g., moving, rotating, or changing the orientation of virtual content).

Examples of the user devices 120 include VR, AR, MR and general computing devices with displays, including: head-mounted displays; sensor-packed wearable devices with a display (e.g., glasses); mobile phones; tablets; or other computing devices that are suitable for carrying out the functionality described in this disclosure. Depending on implementation, the components shown in the user devices 120 can be distributed across different devices (e.g., a worn or held peripheral separate from a processor running a client application that is communicatively coupled to the peripheral).

Having discussed features of systems on which different embodiments may be implemented, attention is now drawn to different processes for determining values of conditions experienced by a user, and using the values of the conditions to determine a value of a user permission to apply to the user.

### Determining Values of Conditions Experienced by a User, and Using the Values of the Conditions to Determine a Value of a User Permission to Apply to the User

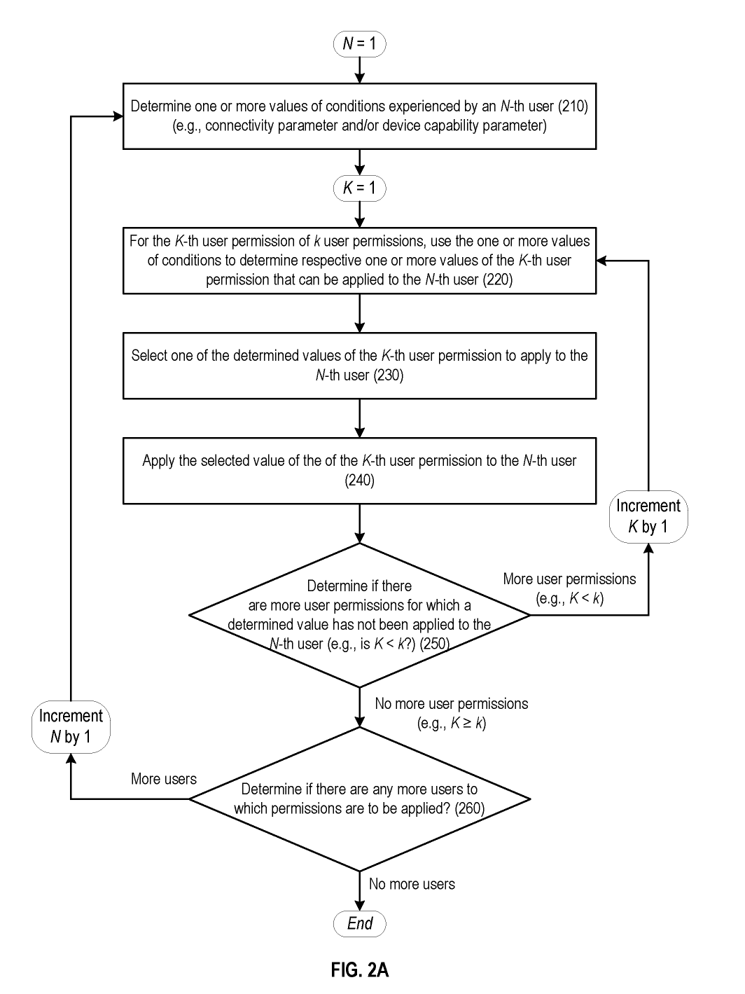

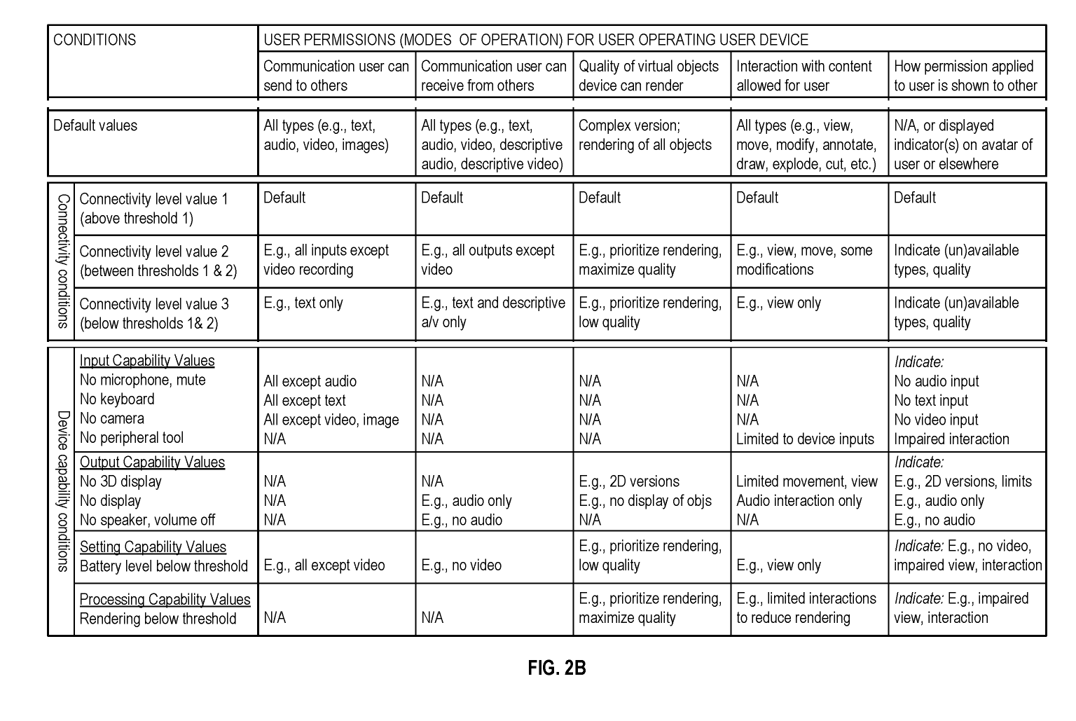

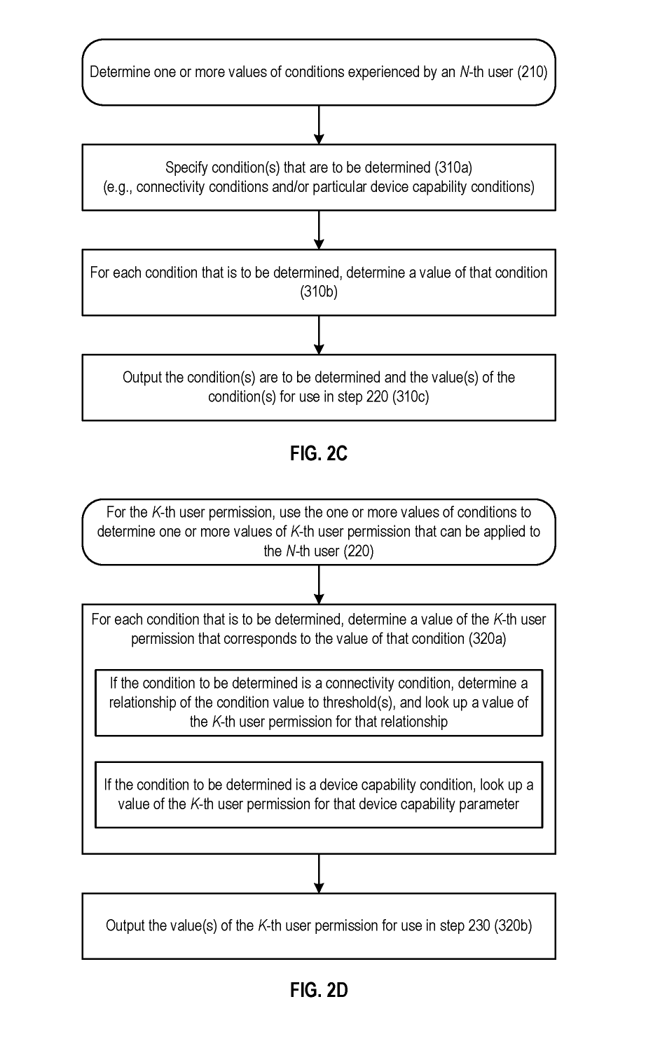

A process for selecting values of user permissions to apply to a user based on conditions experienced by the user is shown in FIG. 2A. Using the processes below to apply different user permissions to different users is advantageous during a virtual meeting that is concurrently attended by the different users, or when the users are collaborating with each other. The application of different user permissions allow all of the different users to view and interact with virtual content and/or to communicate with each other despite different conditions that are being experienced by the different users.

As shown, one or more values of conditions experienced by an N-th user are determined (210). An illustrative process for determining values of one or more conditions during step 210 is provided in FIG. 2C, which is discussed later. Examples of conditions and associated condition values are provided in FIG. 2B, which is discussed later.

For a K-th user permission of k user permissions, the one or more values of conditions are used to determine respective one or more values of the K-th user permission that can be applied to the N-th user (220). An illustrative process for determining one or more values of a user permission during step 220 is provided in FIG. 2D, which is discussed later. Examples of user permissions and values of user permissions are provided in FIG. 2B, which is discussed later.

One of the determined values of the K-th user permission is selected for application to the N-th user (230). By way of example, selection of a value among other values of a user permission to apply to the N-th user during step 230 may be accomplished by determining which of the values is most limiting, and then selecting the most-limiting value.

The selected value of the of the K-th user permission is applied to the N-th user (240).

A determination is made as to whether there are more user permissions for which a determined value has not been applied to the N-th user (e.g., is K<k?) (250). If there are more user permissions for which a determined value has not been applied to the N-th user (e.g., is K<k), steps 220 through 250 are repeated for the other user permissions. If there are no more user permissions for which a determined value has not been applied to the N-th user (e.g., is K≥k), a determination is made as to whether there are any more users to which user permission values are to be applied (260). If there are more users, steps 210 through 260 are repeated for the other users. If there are no more users, the process ends.

Examples of conditions and associated values that may be determined are provided in FIG. 2B, which shows different connectivity condition values and device capability condition values. As shown in FIG. 2B, conditions may include a connectivity condition with any number of two or more values (e.g., a first connectivity level value above a first threshold, a second connectivity level value below the first threshold (and optionally above a second threshold), and/or optionally a third connectivity level value below the second threshold). Conditions may also or alternatively include device capability conditions and associated values, including: user input capabilities (e.g., values: no microphone is available on the device, the microphone is muted, no keyboard is available on the device, no camera is available on the device, and/or no peripheral tool is available in connection with the device); device output capabilities (e.g., values: no 3D display is available on the device, no display is available on the device, no speaker is available on the device, and/or the volume of the device is off or below a threshold level of volume required to hear audio output), setting capabilities (e.g., values: the battery level of the device is below a battery level threshold), and/or processing or rendering capabilities (e.g., values: processing power or capacity available for rendering is below a processing level threshold; a graphics card of the device does or does not support predefined level(s) of rendering). Conditions may also or alternatively include conditions and associated values related to memory—e.g., values: memory capacity of a device can store a maximum size of virtual content such that the virtual content sent to that device is below that maximum size, or memory capacity of a device can support processing of a maximum processing size of virtual content such that the virtual content sent to that device is below that maximum processing size).

Different user permission values for each condition value are shown in the same row as that condition value in FIG. 2B. User permissions and values of those user permissions may include the following: types of communication by the user to others (values: all types of inputs (e.g., text, audio, video) by the user are allowed, all inputs except video input by the user are allowed, only text input by the user is allowed, no audio input by the user is allowed, no text input by the user is allowed, and/or no video input by the user is allowed); communication from others (values: all types of outputs (e.g., text, audio, video, text description of audio, text or audio description of video) to the user are allowed, all outputs except video output to the user are allowed, only text or text description of audio or video output to the user are allowed, only audio output to the user is allowed, no audio output to the user is allowed, and/or no video output to the user is allowed); quality of virtual objects displayed to user (values: the qualities of rendered virtual objects are complex versions of those virtual objects, the qualities of rendered virtual objects are less than the complex versions of those virtual objects but maximized to be better than lowest quality versions, the qualities of rendered virtual objects are the lowest quality versions compared to other versions, only some virtual objects are rendered based on a priority of that virtual object over other virtual object(s), virtual objects are rendered in 2D instead of 3D, and/or no virtual objects are rendered); and allowed interactions by the user within the virtual environment and with virtual objects (values: all types of interactions are allowed (e.g., view, move, modify, annotate, draw, explode, cut, others), only some interactions are allowed (e.g., view, move and some modifications); only interactions assigned to available inputs of the device are allowed; only interactions that limit rendering are allowed, such as viewing the external surfaces of a virtual object and some movements around the virtual object, but not exploding the virtual object to view inside the virtual object; some interactions are limited (e.g., allowing the user to view only a limited number of virtual objects or some of the virtual environment at a time when a 2D screen of a particular size is in use); or only one type of interaction is allowed (e.g., viewing virtual objects only, or audio/speech-recognition-initiated interactions only)).

In some embodiments, where two condition values result in a different value for the same user permission, the most-restrictive value is selected. For example, a battery level below a battery level threshold permits all inputs except video recording by the user, and a connectivity level value 3 permits only text inputs by the user. In this case, the most limiting user permission value is associated with the connectivity level value 3, which permits only text inputs by the user. Thus, the user permission value that applies to the user/user device would be that only text inputs by the user are allowed.

Applying any user permission value can be accomplished in different ways—e.g., an application on the user device can apply the user permission values, a server can apply the user permission values by sending communications to the user device that are allowed by the user permission values, or other approaches.

An illustrative process for determining values of one or more conditions during step 210 is provided in FIG. 2C. As shown, condition(s) that are to be determined are specified (310a), where the specification of conditions is automatic, based on user input, or determined from another approach. A value of each specified condition is determined (310b)—e.g., by measuring a connectivity value using known approaches and comparing it to one or more connectivity level thresholds, by determining available user inputs, by determining available device outputs, by measuring a battery level using known approaches and comparing it to one or more battery level thresholds, and/or by determining how much processing capacity is available using known approaches and comparing it to different levels of processing required for different levels of rendering. Finally, the specified condition(s) along with the value(s) of the condition(s) are output for use in step 220 (310c).

An illustrative process for determining one or more values of a user permission during step 220 is provided in FIG. 2D. For each specified condition, a value of the K-th user permission that corresponds to the value of that condition is determined (320a), and the value(s) of the K-th user permission are output for use in step 230 (320b). By way of example, if the specified condition to be determined is a connectivity condition, a relationship of the condition value to threshold(s) is determined, and a value of the K-th user permission for that relationship is looked up from a storage device. By way of another example, if the condition to be determined is a device capability condition, a value of the K-th user permission for that device capability condition value is looked up from a storage device.

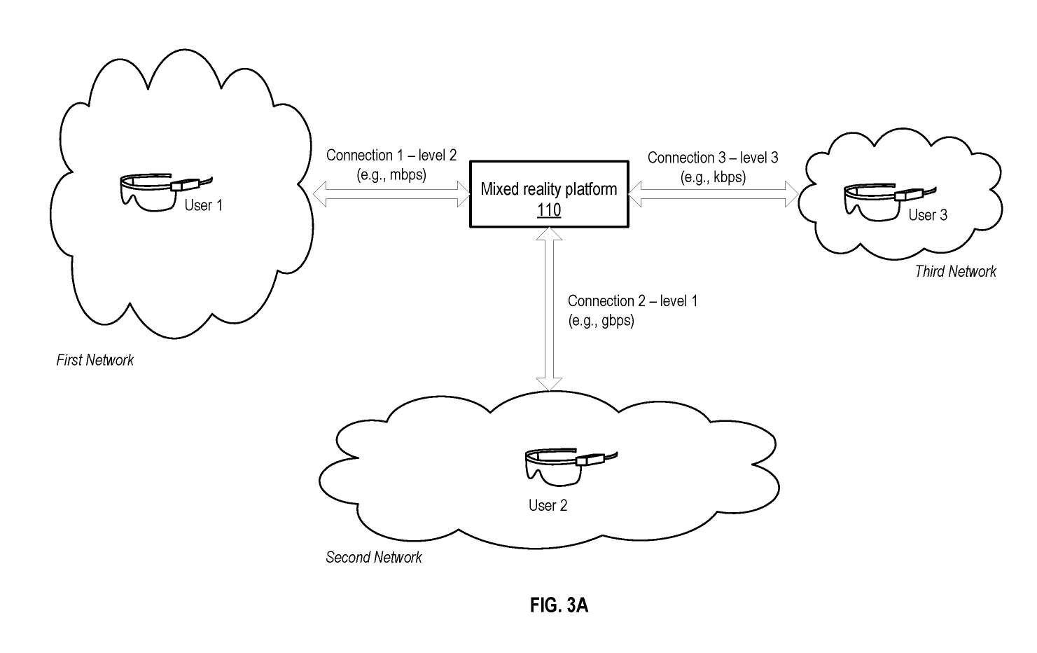

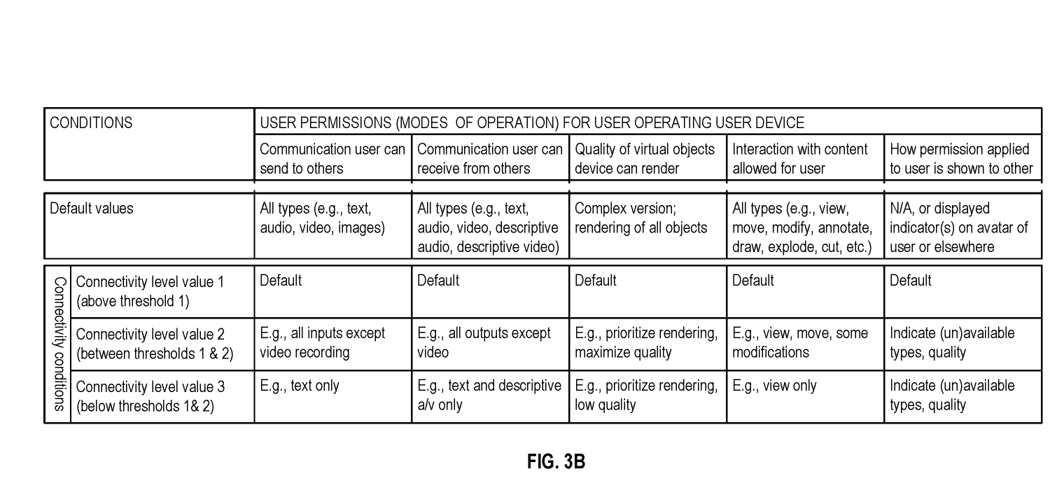

FIG. 3A depicts a plurality of networks where each network has a particular connectivity level value—e.g., the first network has a first connectivity level value of 2, the second network has a second connectivity level value of 1, and the third network has a third connectivity level value of 3. The connectivity level values may be used to look up user permission values shown in FIG. 2B, which are reproduced in FIG. 3B. Three networks are shown, but any number of networks are possible. Also, each network need not have a different connectivity level such that two networks may have the same connectivity level. Connectivity levels may include levels of throughput (e.g., kilo/mega/gigabytes per second, or another measurement) that are determined using known approaches for determining throughput. Alternatively, connection levels may include levels of latency, or another measurement of connectivity. The value of a connectivity condition is shown as a level that comprises a range of connectivity measurements. Other values of connectivity conditions are possible.

FIG. 3B depicts a table of values for connectivity conditions and associated user permission values that can be applied to the first user, the second user, and the third user introduced in FIG. 3A. The table includes a subset of condition values and associated user permission values from FIG. 2B. For purposes of illustration, a first network has a first connection with a first connectivity level value of 2 that is experienced by the first user, a second network has a second connection with a second connectivity level value of 1 that is experienced by the second user, and a third network has a third connection with a third connectivity level value of 3 that is experienced by the third user. The values are provided only for illustration, and each network need not have a different connectivity level value.

By way of example, since the first user is experiencing the first connectivity level value of 2, the following user permission values apply to the first user: all inputs by the first user except video are allowed; all outputs by the device to the first user except video are allowed (e.g., such that any video output by another user is converted to descriptive audio or text at the platform 110 before the descriptive audio or text is sent to the device of the first user); rendering of virtual objects are prioritized (e.g., virtual objects in view or being interacted with by the first user or other user are rendered before other objects not in view or not being interacted with the first user or other user); the qualities of virtual objects displayed on the device of the first user is less than some versions of the virtual objects, but better than lower versions of the virtual objects; and/or interactions by the first user with virtual objects are restricted to a subset of the default types of interactions.

By way of example, since the second user is experiencing the second connectivity level value of 1, all default user permission values apply to the second user, including: all inputs by the first user are allowed; all outputs by the device to the first user are allowed; rendering of virtual objects need not be prioritized; the qualities of virtual objects displayed on the device of the first user are complex versions of the virtual objects; and/or interactions by the first user with virtual objects are not restricted.

By way of example, since the third user is experiencing the third connectivity level value of 3, the following user permission values apply to the third user: only text input by the first user is allowed; only text and descriptive text about audio or video are allowed (e.g., such that any audio or video output by another user is converted to descriptive text at the platform 110 before the descriptive text is sent to the device of the third user); rendering of virtual objects are prioritized; the qualities of virtual objects displayed on the device of the third user are the lower versions of the virtual objects; and/or interactions by the third user with virtual objects are restricted more than the first user (e.g., the third user is only allowed to view the virtual objects).

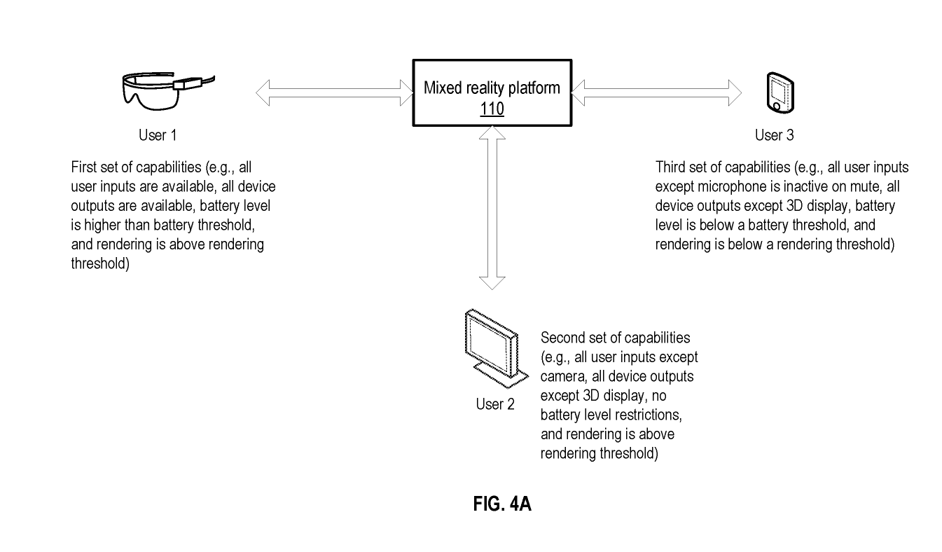

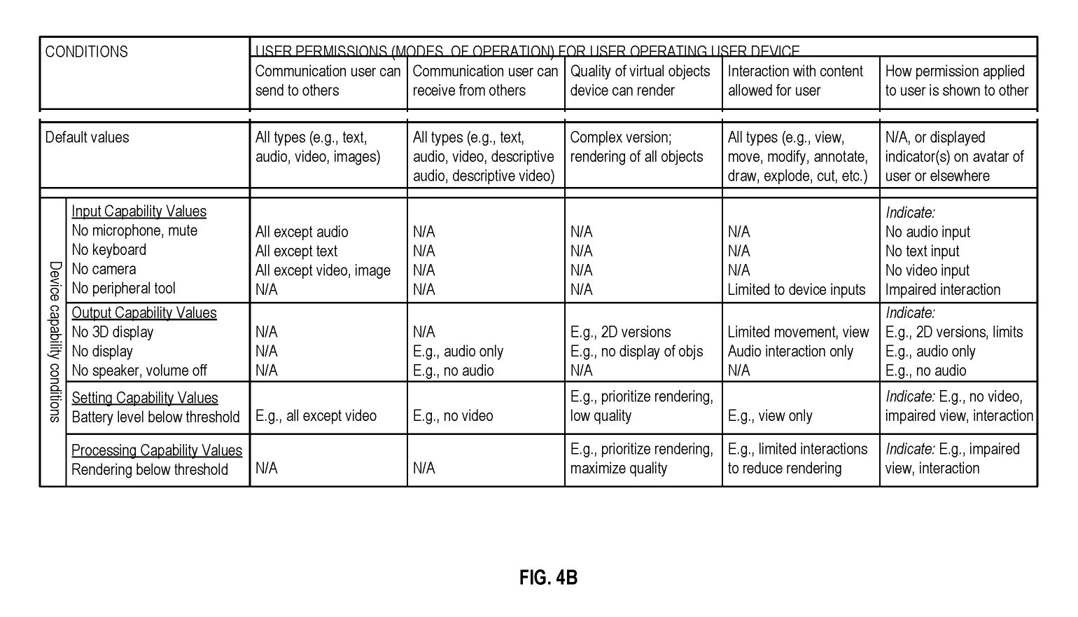

FIG. 4A depicts a plurality of users and user devices where each user or user device has a particular set of device capability value(s)—e.g., the first user operates a first user device (e.g., AR/VR headset) that has a first set of device capability values, the second user operates a second user device (e.g., desktop computer) that has a second set of device capability values, and the third user operates a third user device (e.g., mobile computing device like a smart phone) hat has a third set of device capability values. The different sets of device capability values may be used to look up associated user permission values shown in FIG. 2B, which are reproduced in FIG. 4B. Three devices are shown, but any number of devices is possible. Also, any of the devices can be on the same network or different networks. Device capabilities are determined using known approaches for determining each device capability. By way of example the first set of device capability values includes all user inputs, all device outputs, a battery level above a battery threshold (no battery level restrictions), and rendering processing above a rendering processing threshold; the second set of device capability values includes all user inputs except a camera, all device outputs except a 3D display, a battery level above a battery threshold (no battery level restrictions), and rendering above a rendering threshold; and the third set of device capability values includes all user inputs except microphone on mute, all device outputs except 3D display, battery level below a battery threshold (battery level restrictions), and rendering below a rendering threshold.

FIG. 4B depicts a table of values for device capability conditions and associated user permission values that can be applied to the first user, the second user, and the third user introduced in FIG. 4A. The table includes a subset of condition values and associated user permission values from FIG. 2B.

For purposes of illustration, the device of the first user is assumed to have full capabilities (e.g., all user inputs are available, all device outputs are available, battery level is higher than battery threshold, and available processing for rendering is above a processing threshold), so the associated permission values would be default values.

By way of example, possible condition values for device capabilities of the second user's device along with associated permission values, which are enclosed in parentheses include: no camera (no video input by user); no 3D display (2D versions of virtual objects are rendered); battery level N/A (default values), and processing available for rendering above a processing threshold (default values). Selected permission values that are most-restricting would include default values except for: no video input (from no camera) as communication inputs to other users; default types of communication received from other users; virtual objects are displayed in 2D (from no 3D display); the quality of a virtual object is complex; rendering of different virtual objects need not be prioritized; and all types of interactions are permitted.

Examples of possible condition values for device capabilities of the third user's device along with associated permission values, which are enclosed in parentheses include: mute (no audio input by user); no 3D display (2D versions of virtual objects); battery level below battery threshold (no video input by user, no video from others is provided to the user, prioritize rendering, low quality of virtual objects, the only allowed interaction is viewing); processing available for rendering is below a processing threshold (prioritize rendering, maximize quality of virtual objects, interactions that minimize rendering are allowed). By way of example, selected permission values that are most-restricting would include default values except for: no audio input (from mute) and no video input (from battery level below battery threshold) as communication inputs to other users; no video (from battery level below battery threshold) as communication from other users provided to the user; virtual objects are displayed in 2D (from no 3D display), the quality of virtual objects is low (from battery level below battery threshold); rendering of different virtual objects is prioritized (from battery level below battery threshold, and from processing available for rendering below a processing threshold); and the third user can only view virtual objects (from battery level below battery threshold). If a condition value changes, such as when the battery level is charged above the battery level threshold, then the selected permission values that are most-restricting change—e.g., no audio input (from mute) as communication input to other users is still applied; video input would be available as a communication input to others; video would be available as communication received from other users; virtual objects are still displayed in 2D (from no 3D display); the quality of virtual objects is now maximized (from processing available for rendering below a processing threshold); rendering of different virtual objects is still prioritized (from processing available for rendering below a processing threshold); and more interactions are allowed beyond view only (from processing available for rendering below a processing threshold). By way of example, the additional interactions may include moving, modifying, annotating or drawing on a virtual object, but not exploding it to see its inner contents that would have to be newly rendered.

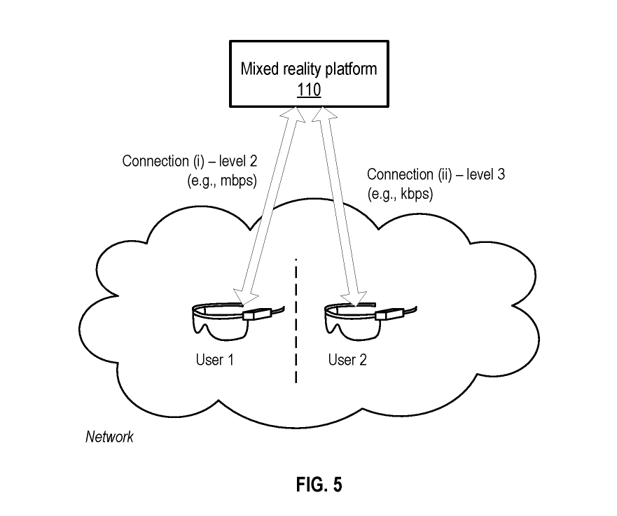

FIG. 5 depicts a plurality of users and user devices where each user and user device are on the same network, but different connectivity levels (as user permission values) apply to different users/devices based on user conditions. For example, a first user may be allowed a higher connectivity level compared to a second user with a lower connectivity level based on a first value of a condition for the first user that is preferred over a second value of the condition. By way of example, one condition includes any of the device capabilities (e.g., a higher connectivity level is given to the user with certain available inputs and/or certain available outputs, or a certain battery level relative to a battery level threshold, or a certain amount of processing available for rendering relative to a processing level threshold). By way of another example, another condition value is based on a user's activity in a virtual environment or interaction with a virtual object (e.g., a higher connectivity level is given to the user that is interacting with a virtual object, moving through the virtual environment, or another activity).

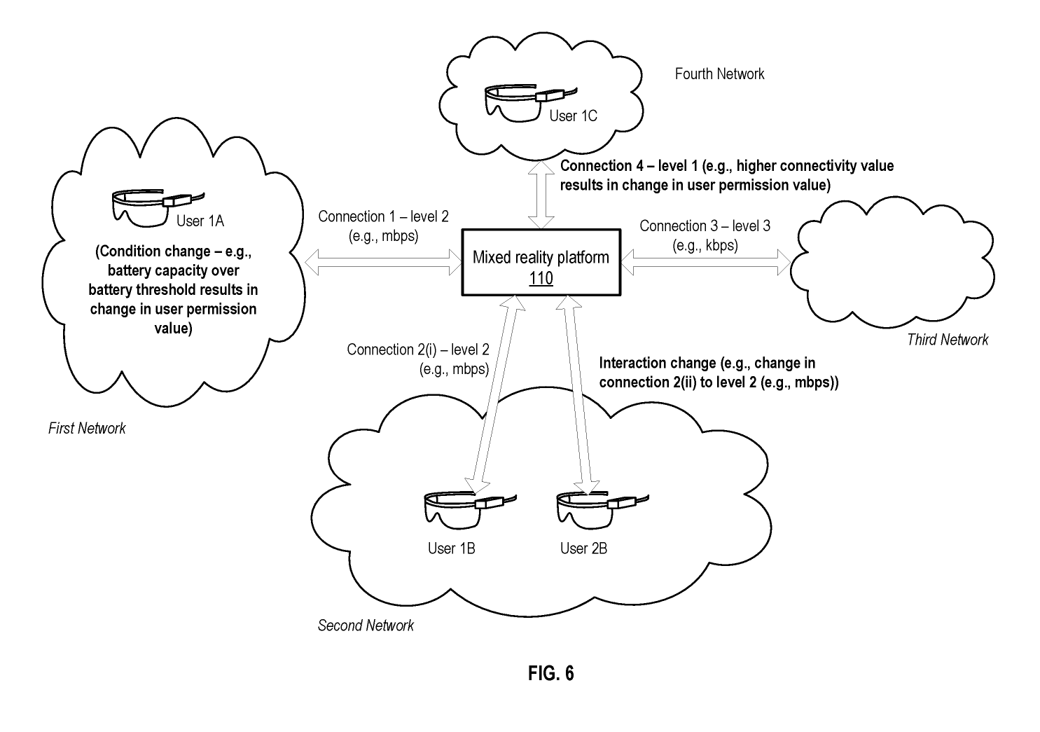

FIG. 6 depicts changes in condition values, which may result in application of different user permission values.

As shown, a condition change for device capability (e.g., for User IA) results in new user permission values being applied to that user. By way of example, if a device capability condition value changes from a battery level below a battery threshold to a battery level above the battery threshold, such as when a device is plugged in after previously discharging below the battery threshold, the user permission values associated with the battery level change from (i) first values (e.g., all user inputs except microphone are available, all device outputs except 3D display are available, the values associated with battery level being below a battery threshold, and the values associated with processing available for rendering being below a processing threshold) to (ii) second values (e.g., all user inputs are available, all device outputs are available, the values associated with battery level being higher than the battery threshold, and the values associated with processing available for rendering being above the processing threshold). Changes also occur as user inputs or user outputs change (e.g., a user device is unmuted making audio input available, or the volume of a user device is increased over a threshold level such that a user can hear audio outputs). The final user permission values that apply to the user may depend on values of other conditions (e.g., connectivity conditions).

By way of another example, if an interaction condition value of a user (e.g., User 2B) changes from one value (e.g., not interacting with a virtual object in a virtual environment) to another value (e.g., interacting with the virtual object in the virtual environment), the user permission values associated with the connectivity change from a first value (e.g., one connectivity level applied to the user) to a second value (e.g., a different connectivity level applied to the user). The final user permission values applied to the user may depend on values of other conditions (e.g., connectivity conditions, device capability conditions).

By way of another example, if a connectivity condition value of a user (e.g., User 1C) changes from one level (e.g., level 3) to another level (e.g., level 1), the user permission values associated with the connectivity change from first values (e.g., only text input by the user is allowed, only text and descriptive text about audio or video are provided to the user, rendering of virtual objects are prioritized, the quality of virtual objects displayed on the device of the user are the lower versions of the virtual objects, and/or interactions by the user with virtual objects are restricted) to second values (e.g., all default user permission values apply to the user). The final user permission values that apply to the user may depend on values of other conditions (e.g., device capability conditions). Such a change in network connectivity may occur on the same network (e.g., having stronger signaling after moving within a wireless network), or by switching networks.

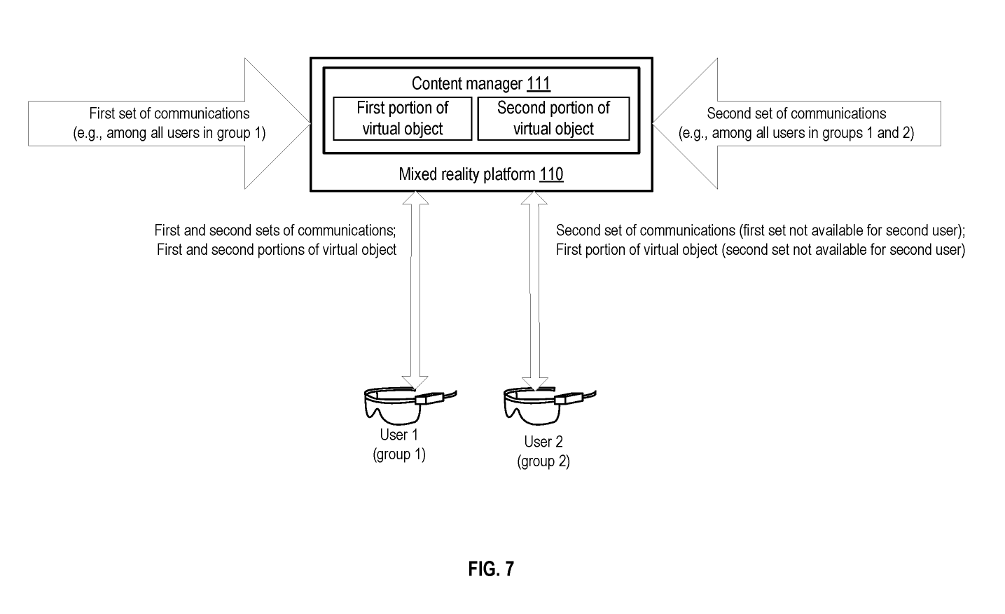

FIG. 7 depicts different groups of users and user devices where different user permission values apply to each group based on different values of conditions experienced by the users/user devices of that group. In one embodiment, each condition value for each user is based on a security level for that user—e.g., a first user (User 1) is part of a first group (group 1) that has a first level of security, and a second user (User 2) is part of a second group (group 2) that does not have the first level of security and/or that has a second level of security—and, different user permission values (e.g., which portions of a virtual object can be seen, or which communications can be received) apply to the different users depending on the different condition values. In one implementation, the users with the first security level are able to see more portions of a virtual object (e.g., first and second portions) than the users without the first security level (e.g., who cannot see the second portion of the virtual object, which may be designated for restricted viewing to only certain users). In another implementation, the users with the first security level are able to receive more communications (e.g., first and second sets of communications) than the users without the first security level (e.g., who cannot receive the first set of communications created by users in the first group). Other ways to group users other than using security levels are contemplated, including user-designated groups, preset groups within an organization, or other ways of forming groups. The security of the data connection for a user can also be determined, and used as a condition—e.g., a first user (User 1) is part of a first group (group 1) that has a connection with a first level of security, and a second user (User 2) is part of a second group (group 2) that does not have a connection with the first level of security and/or that has a connection with a second level of security.

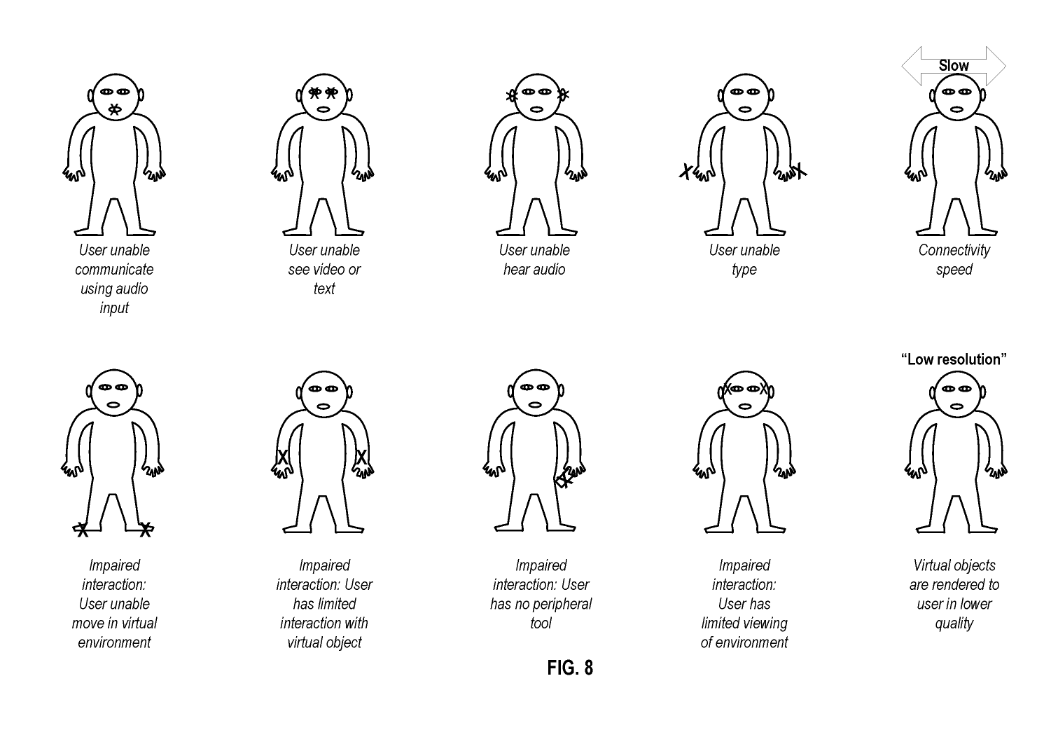

FIG. 8 depicts different visual indicators that represent user permission values that apply to a first user, where the different visual indicators are displayed to other users. Different indicators are provided with an avatar of the first user, which may be seen by the other users when the other users view a virtual environment that contains the avatar. The indicators may be viewed by the other users so those other users are aware of the user permissions that apply to the first user. The indicators can take other forms than the forms shown in FIG. 8 so long as those other forms indicate the specified user permissions that apply to the first user. Instead of indicating what the user is unable to do, the indicators can illustrate what the user is able to do—e.g., a keyboard indicating user is only able to input text or read text. Indicators need not be shown on an avatar, and may be shown elsewhere.

User permissions can alternatively be considered as user modes of operation.

### Particular Embodiments

Different embodiments in this section detail different methods for determining values of conditions experienced by a user operating a user device, and using the values of the conditions to determine a value of a permission to apply to the user. The method of each embodiment and implementation comprises: determining a value of a first condition experienced by the user operating the user device; using the value of the first condition experienced by the user to determine a value of a first permission associated with the value of the first condition that can be applied to the user; and applying the value of the first permission or another value of the first permission to the user.

In a first embodiment, applying the value of the first permission or another value of the first permission to the user comprises: allowing the user to perform only actions that are specified by the value of the first permission or another value of the first permission that is applied to the user.

In a second embodiment, the value of the first condition experienced by the user is a level of connectivity available to the user, a value of a device input capability available to the user, a value of a device output capability available to the user, a value of a device setting capability available to the user, or a value of a processing capability available to the user.

In an implementation of the second embodiment, the value of the first condition experienced by the user is the level of connectivity available to the user, and using the value of the first condition experienced by the user to determine the value of the first permission that can be applied to the user comprises: comparing the level of connectivity available to the user to a first threshold level of connectivity; if the level of connectivity available to the user is below the first threshold level of connectivity, determining that the value of the first permission is a first stored value of the first permission; and if the level of connectivity available to the user is not below the first threshold level of connectivity, determining that the value of the first permission is a second stored value of the first permission that is different than the first stored value of the first permission.

In an implementation of the second embodiment, (i) the value of the first condition experienced by the user is a value of a device input capability available to the user, a value of a device output capability available to the user, a value of a device setting capability available to the user, or a value of a processing capability available to the user, and (ii) using the value of the first condition experienced by the user to determine the value of the first permission that can be applied to the user comprises: determining that the value of the first permission is a stored value of the first permission that is associated with the value of the first condition.

In an implementation of the second embodiment, the value of the first permission specifies one or more available types of communication that the user can send to another user, one or more available types of communication that the user can receive from another user, a maximum level of quality for any virtual object that the user device can render, or one or more interactions with virtual content that are allowed for user.

In an implementation of the second embodiment or in any of the implementations of the second embodiment, applying the value of the first permission or another value of the first permission to the user comprises: allowing the user to generate or send only the one or more available types of communication that the user can send to another user, allowing the user to receive the only one or more available types of communication that the user can receive from another user, allowing the user device to receive a version of virtual object with a quality that is no greater than the maximum level of quality for any virtual object that the user device can render, or allowing the user to interact with virtual content using only the one or more interactions with virtual content that are allowed for user.

In a third embodiment, the method comprises: determining a value of a second condition experienced by the user; using the value of the second condition experienced by the user to determine another value of the first permission that can be applied to the user; selecting, from a group of permission values that includes the value of the first permission and the other value of the first permission, a permission value of to apply to the user; and applying the selected permission value of the first permission to the user.

In an implementation of the third embodiment, applying the selected permission value comprises: allowing the user to perform only actions that are specified by the selected permission value.

In an implementation of the third embodiment, the value of the first condition experienced by the user and the value of the second condition experienced by the user are different values from a group of condition values that includes two or more of a level of connectivity available to the user, a value of a device input capability available to the user, a value of a device output capability available to the user, a value of a device setting capability available to the user, or a value of a processing capability available to the user.

In an implementation of the third embodiment, (a) the value of the first condition experienced by the user is the level of connectivity available to the user, (b) the value of the second condition experienced by the user is a value of a device input capability available to the user, a value of a device output capability available to the user, a value of a device setting capability available to the user, or a value of a processing capability available to the user, (c) using the value of the first condition experienced by the user to determine the value of the first permission that can be applied to the user comprises (i) comparing the level of connectivity available to the user to a first threshold level of connectivity, (ii) if the level of connectivity available to the user is below the first threshold level of connectivity, determining that the value of the first permission is a first stored value of the first permission, and (iii) if the level of connectivity available to the user is not below the first threshold level of connectivity, determining that the value of the first permission is a second stored value of the first permission that is different than the first stored value of the first permission, and (d) using the value of the second condition experienced by the user to determine the other value of the first permission that can be applied to the user comprises: determining that the other value of the first permission is a third stored value of the first permission that is associated with the value of the second condition.

In an implementation of the third embodiment, (a) the value of the first condition experienced by the user and the value of the second condition experienced by the user are different values from a group of condition values that includes two or more of a value of a device input capability available to the user, a value of a device output capability available to the user, a value of a device setting capability available to the user, or a value of a processing capability available to the user, (b) using the value of the first condition experienced by the user to determine the value of the first permission that can be applied to the user comprises determining that the value of the first permission is a first stored value of the first permission that is associated with the value of the first condition, and (c) using the value of the second condition experienced by the user to determine the other value of the first permission that can be applied to the user comprises determining that the other value of the first permission is a second stored value of the first permission that is associated with the value of the second condition.

In an implementation of the third embodiment or any of the implementations of the third embodiment, The method of claim 11, the selected permission value is either the value of the first permission or the other value of the first permission, and the selecting a permission value to apply to the user comprises: determining which of the value of the first permission and the other value of the first permission specifies the most is the most-limiting permission value; and setting the selected permission value as the most-limiting permission value of the value of the first permission and the other value of the first permission.

In any of the above embodiments or implementations, the method comprises: repeating the steps of that embodiment or implementation for another user instead of the user, wherein the value of the first condition experienced by the user is different than the value of the first condition experienced by the other user, wherein the value of the first permission applied to the user is different than the value of the first permission applied to the other user.

In any of the above embodiments or implementations, the method comprises: repeating the steps of that embodiment or implementation for a second permission instead of the first permission.

In any of the above embodiments or implementations, the user device operated by user is a virtual reality, an augmented reality, or a mixed reality device.

Systems that comprise one or more machines and one or more non-transitory machine-readable media storing instructions that are operable, when executed by the one or more machines, to cause the one or more machines to perform operations of any of the above embodiments or implementations are contemplated.

One or more non-transitory machine-readable media embodying program instructions that, when executed by one or more machines, cause the one or more machines to implement any of the above embodiments or implementations are contemplated.

### Supporting a Multitude of Devices with Differing Capabilities and Connectivity in Virtual Environments

Additional embodiments are described below for providing support for devices that are VR, AR and MR capable, but may not provide the best experience due to limited memory, processing power, graphics card and connectivity.

One aspect of this section is a method for supporting a plurality of devices with different capabilities and connectivity. The method includes identifying a device type, a device capability and/or a device connectivity for each device of a plurality of client devices to participate in a virtual environment. The method also includes requesting a copy of virtual assets for the virtual environment from a content management system, wherein the request comprises the device type, the device capability, and the device connectivity for each client device of the plurality of client devices to participate in the virtual environment. The method also includes determining, at a content management system, a format and quality for a plurality of virtual assets that each device of the plurality of devices can support (e.g., in one embodiment, a format and quality for each of the plurality of virtual assets that can be supported by all devices is determined; e.g., in another embodiment, individually for each device, a format and quality for each of the plurality of virtual assets that can be supported by that device is determined). The method also includes receiving the plurality of virtual assets at the collaboration manager from the content management system. The method also includes distributing each of the plurality of virtual assets to each of the plurality of client devices according to the device type, the device capability and the device connectivity for each client device of the plurality of client devices. The virtual environment is a virtual reality environment, an augmented reality environment or a mixed reality environment.

Another aspect of this section is a system for supporting a plurality of devices with different capabilities and connectivity. The system comprises a collaboration manager at a server, a content management system, and a plurality of client devices. The collaboration manager is configured to identify a device type, a device capability and a device connectivity for each device of a plurality of client devices to participate in a virtual environment. The collaboration manager is configured to request a copy of a plurality of virtual assets for the virtual environment from a content management system, wherein the request comprises the device type, the device capability and the device connectivity for each client device of the plurality of client devices to participate in the virtual environment. The content management system is configured to determine a format and quality for a plurality of virtual assets that each device of the plurality of devices can support. The collaboration manager is configured to receive the plurality of virtual assets at the collaboration manager from the content management system. The collaboration manager is configured to distribute each of the plurality of virtual assets to each of the plurality of client devices according to the device type, the device capability and the device connectivity for each client device of the plurality of client devices. The virtual environment is a virtual reality environment, an augmented reality environment or a mixed reality environment.

The collaboration manager learns of each device type attempting to participate in a collaborative AR, VR, or MR experience. The collaboration manager requests a copy of the AR, VR, and MR assets from a Content Management System (CMS). In the request, the collaboration manager provides the device type for each device that is participating. The CMS uses preconfigured information to determine the format and quality of AR, VR and MR assets that each device can support. The CMS may have multiple copies of the assets in storage, one for each set of specifications devices may support, or the CMS may have a converter to automatically reduce the quality of an asset such that a device with reduced functionality can view the asset.

After retrieving the assets, the collaboration manager may need to cache the assets and send the asset in “chunks” in order to support devices that are on lower bandwidth or very lossy connections. In addition, since the graphics renderer may be on a device or on a computer that is an adjunct to the display device, the collaboration manager may deliver the assets to the renderer which has functionality to handle devices that have reduced processing power and little or no cache. The renderer will reduce the amount of data provided to the display device and/or reduce the quality of the data in order to provide the best possible viewing experience on the display device to the user.

One embodiment is a method for supporting a plurality of devices with different capabilities and connectivity. The method includes identifying a device type, a device capability and a device connectivity for each device of a plurality of client devices to participate in a virtual environment. The method also includes requesting a copy of virtual assets for the virtual environment from a content management system, wherein the request comprises the device type, the device capability and the device connectivity for each client device of the plurality of client devices to participate in the virtual environment. The method also includes determining at the content management system a format and quality for a plurality of virtual assets that each device of the plurality of devices can support. The method also includes receiving the plurality of virtual assets at the collaboration manager from the content management system. The method also includes distributing each of the plurality of virtual assets to each of the plurality of client devices according to the device type, the device capability and the device connectivity for each client device of the plurality of client devices. The virtual environment is a virtual reality environment, an augmented reality environment or a mixed reality environment.

In one embodiment, the client device of each of the plurality of client devices comprise at least one of a personal computer, a HMD, a laptop computer, a tablet computer or a mobile computing device.

In one embodiment, the method further comprises caching the plurality of assets at the collaboration manager.

In one embodiment, the method further comprises transmitting a virtual asset of the plurality of virtual assets from the collaboration manager to a renderer to reduce at least one of a quality of data or an amount of data prior to transmission to a client device of the plurality of client devices, wherein the renderer is configured with the data specifications for the client device.

In one embodiment, the method further comprises a converter to automatically reduce a quality of a virtual asset of the plurality of virtual assets for transmission to a client device with reduced functionality.

In one embodiment, the device connectivity is a bandwidth for transmission to a client device.

In one embodiment, each copy of the plurality of copies has a specification for each device of the plurality of client devices.

In one embodiment, the content management system comprises a plurality of copies of each of the plurality of virtual assets in storage.

In one embodiment, the client device of each of the plurality of client devices comprise at least one of a personal computer, a HMD, a laptop computer, a tablet computer or a mobile computing device.

In one embodiment, the plurality of virtual assets comprises a whiteboard, a conference table, a plurality of chairs, a projection screen, a model of a jet engine, an model of an airplane, a model of an airplane hanger, a model of a rocket, a model of a helicopter, a model of a customer product, a tool used to edit or change a virtual asset in real time, a plurality of adhesive notes, a projection screen, a drawing board, a 3-D replica of at least one real world object, a 3-D visualization of customer data, a virtual conference phone, a computer, a computer display, a replica of the user's cell phone, a replica of a laptop, a replica of a computer, a 2-D photo viewer, a 3-D photo viewer, 2 2-D image viewer, a 3-D image viewer, a 2-D video viewer, a 3-D video viewer, a 2-D file viewer, a 3-D scanned image of a person, 3-D scanned image of a real world object, a 2-D map, a 3-D map, a 2-D cityscape, a 3-D cityscape, a 2-D landscape, a 3-D landscape, a replica of a real world, physical space, or at least one avatar

An alternative embodiment is a system for supporting a plurality of devices with different capabilities and connectivity. The system comprises a collaboration manager at a server, a content management system, and a plurality of client devices. The collaboration manager is configured to identify a device type, a device capability and a device connectivity for each device of a plurality of client devices to participate in a virtual environment. The collaboration manager is configured to request a copy of a plurality of virtual assets for the virtual environment from a content management system, wherein the request comprises the device type, the device capability and the device connectivity for each client device of the plurality of client devices to participate in the virtual environment. The content management system is configured to determine a format and quality for a plurality of virtual assets that each device of the plurality of devices can support. The collaboration manager is configured to receive the plurality of virtual assets at the collaboration manager from the content management system. The collaboration manager is configured to distribute each of the plurality of virtual assets to each of the plurality of client devices according to the device type, the device capability and the device connectivity for each client device of the plurality of client devices. The virtual environment is a virtual reality environment, an augmented reality environment or a mixed reality environment.

In one embodiment, the system further comprises a host display device.

In one embodiment, the device connectivity is a bandwidth for transmission to a client device.

In one embodiment, the content management system preferably comprises a plurality of copies of each of the plurality of virtual assets in storage. Each copy of the plurality of copies has a specification for each device of the plurality of client devices.

In one embodiment, the content management system preferably resides at the server. The converter preferably resides at the collaboration manager. The collaboration manager preferably reduces a functionality of a device due to device capability and/or bandwidth.

In one embodiment, the client device of each of the plurality of client devices comprise at least one of a personal computer, a HMD, a laptop computer, a tablet computer or a mobile computing device

In one embodiment, the system caches the plurality of assets at the collaboration manager.

In one embodiment, the system transmits a virtual asset of the plurality of virtual assets from the collaboration manager to a renderer to reduce at least one of a quality of data or an amount of data prior to transmission to a client device of the plurality of client devices, wherein the renderer is configured with the data specifications for the client device

In one embodiment, the system comprises a converter to automatically reduce a quality of a virtual asset of the plurality of virtual assets for transmission to a client device with reduced functionality. For example, the converter resides at the collaboration manager.

In one embodiment, the content management system resides at the server.

In one embodiment, the plurality of virtual assets comprises a whiteboard, a conference table, a plurality of chairs, a projection screen, a model of a jet engine, an model of an airplane, a model of an airplane hanger, a model of a rocket, a model of a helicopter, a model of a customer product, a tool used to edit or change a virtual asset in real time, a plurality of adhesive notes, a projection screen, a drawing board, a 3-D replica of at least one real world object, a 3-D visualization of customer data, a virtual conference phone, a computer, a computer display, a replica of the user's cell phone, a replica of a laptop, a replica of a computer, a 2-D photo viewer, a 3-D photo viewer, 2 2-D image viewer, a 3-D image viewer, a 2-D video viewer, a 3-D video viewer, a 2-D file viewer, a 3-D scanned image of a person, 3-D scanned image of a real world object, a 2-D map, a 3-D map, a 2-D cityscape, a 3-D cityscape, a 2-D landscape, a 3-D landscape, a replica of a real world, physical space, or at least one avatar.

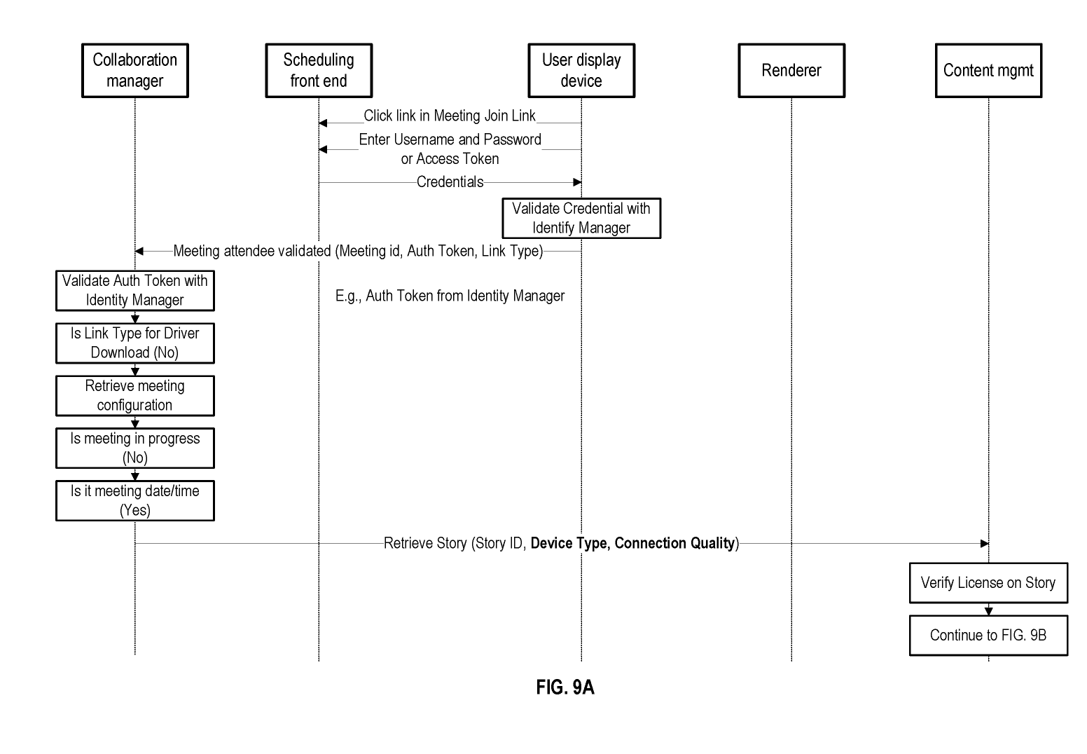

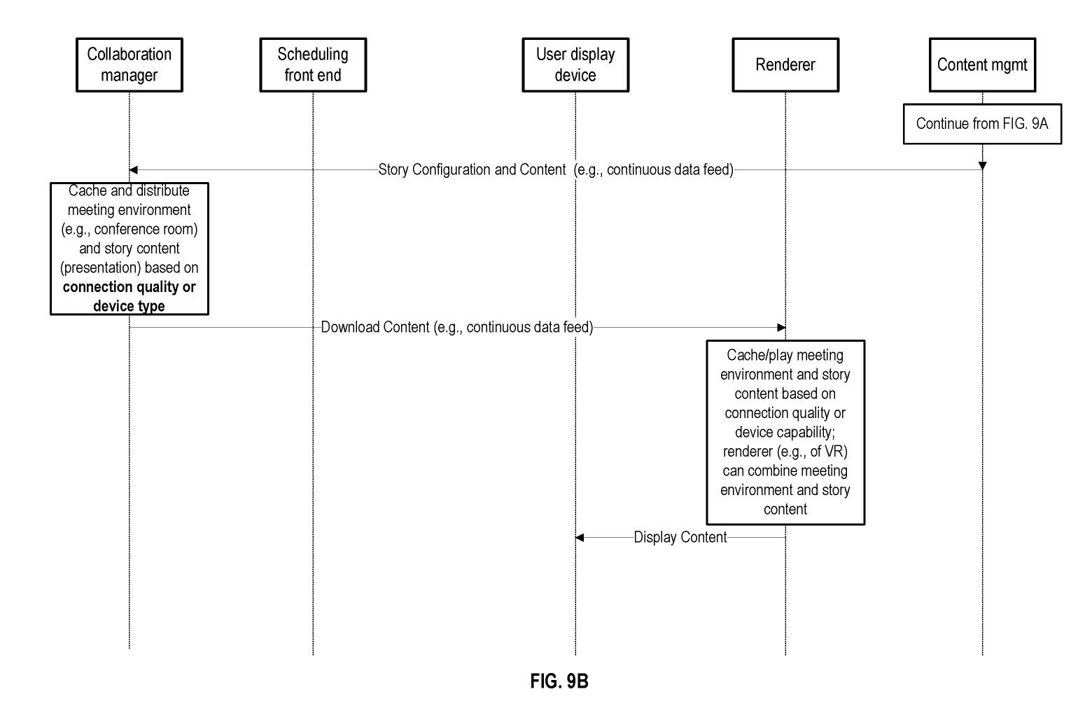

FIG. 9A and FIG. 9B collectively depict a communication sequence diagram for a system for supporting a plurality of devices with different capabilities and connectivity.

A HMD of at least one attendee of the plurality of attendees is structured to hold a client device comprising a processor, a camera, a memory, a software application residing in the memory, an IMU, and a display screen.

The client device of each of the plurality of attendees comprise at least one of a personal computer, HMD, a laptop computer, a tablet computer or a mobile computing device. A HMD of at least one attendee of the plurality of attendees is structured to hold a client device comprising a processor, a camera, a memory, a software application residing in the memory, an IMU, and a display screen.

The display device is preferably selected from the group comprising a desktop computer, a laptop computer, a tablet computer, a mobile phone, an AR headset, and a VR headset.

The user interface elements include the capacity viewer and mode changer.

The human eye's performance. 150 pixels per degree (foveal vision). Field of view Horizontal: 145 degrees per eye Vertical 135 degrees. Processing rate: 150 frames per second Stereoscopic vision Color depth: 10 million? (Let's decide on 32 bits per pixel)=470 megapixels per eye, assuming full resolution across entire FOV (33 megapixels for practical focus areas) Human vision, full sphere: 50 Gbits/sec. Typical HD video: 4 Mbits/sec and we would need>10,000 times the bandwidth. HDMI can go to 10 Mbps.

For each selected environment there are configuration parameters associated with the environment that the author must select, for example, number of virtual or physical screens, size/resolution of each screen, and layout of the screens (e.g. carousel, matrix, horizontally spaced, etc). If the author is not aware of the setup of the physical space, the author can defer this configuration until the actual meeting occurs and use the Narrator Controls to set up the meeting and content in real-time.

The following is related to a virtual meeting. Once the environment has been identified, the author selects the AR/VR assets that are to be displayed. For each AR/VR asset the author defines the order in which the assets are displayed. The assets can be displayed simultaneously or serially in a timed sequence. The author uses the AR/VR assets and the display timeline to tell a “story” about the product. In addition to the timing in which AR/VR assets are displayed, the author can also utilize techniques to draw the audience's attention to a portion of the presentation. For example, the author may decide to make an AR/VR asset in the story enlarge and/or be spotlighted when the “story” is describing the asset and then move to the background and/or darken when the topic has moved on to another asset.

When the author has finished building the story, the author can play a preview of the story. The preview playout of the story as the author has defined but the resolution and quality of the AR/VR assets are reduced to eliminate the need for the author to view the preview using AR/VR headsets. It is assumed that the author is accessing the story builder via a web interface, so therefore the preview quality should be targeted at the standards for common web browsers.

After the meeting organizer has provided all the necessary information for the meeting, the Collaboration Manager sends out an email to each invitee. The email is an invite to participate in the meeting and also includes information on how to download any drivers needed for the meeting (if applicable). The email may also include a preload of the meeting material so that the participant is prepared to join the meeting as soon as the meeting starts.

The Collaboration Manager also sends out reminders prior to the meeting when configured to do so. Both the meeting organizer or the meeting invitee can request meeting reminders. A meeting reminder is an email that includes the meeting details as well as links to any drivers needed for participation in the meeting.

Prior to the meeting start, the user needs to select the display device the user will use to participate in the meeting. The user can use the links in the meeting invitation to download any necessary drivers and preloaded data to the display device. The preloaded data is used to ensure there is little to no delay experienced at meeting start. The preloaded data may be the initial meeting environment without any of the organization's AR/VR assets included. The user can view the preloaded data in the display device, but may not alter or copy it.

At meeting start time each meeting participant can use a link provided in the meeting invite or reminder to join the meeting. Within 1 minute after the user clicks the link to join the meeting, the user should start seeing the meeting content (including the virtual environment) in the display device of the user's choice. This assumes the user has previously downloaded any required drivers and preloaded data referenced in the meeting invitation.

Each time a meeting participant joins the meeting, the story Narrator (i.e. person giving the presentation) gets a notification that a meeting participant has joined. The notification includes information about the display device the meeting participant is using. The story Narrator can use the Story Narrator Control tool to view each meeting participant's display device and control the content on the device. The Story Narrator Control tool allows the Story Narrator to: View all active (registered) meeting participants; View all meeting participant's display devices; View the content the meeting participant is viewing; View metrics (e.g. dwell time) on the participant's viewing of the content; Change the content on the participant's device; and/or Enable and disable the participant's ability to fast forward or rewind the content.

Each meeting participant experiences the story previously prepared for the meeting. The story may include audio from the presenter of the sales material (aka meeting coordinator) and pauses for Q&A sessions. Each meeting participant is provided with a menu of controls for the meeting. The menu includes options for actions based on the privileges established by the Meeting Coordinator defined when the meeting was planned or the Story Narrator at any time during the meeting. If the meeting participant is allowed to ask questions, the menu includes an option to request permission to speak. If the meeting participant is allowed to pause/resume the story, the menu includes an option to request to pause the story and once paused, the resume option appears. If the meeting participant is allowed to inject content into the meeting, the menu includes an option to request to inject content.

The meeting participant can also be allowed to fast forward and rewind content on the participant's own display device. This privilege is granted (and can be revoked) by the Story Narrator during the meeting.

After an AR story has been created, a member of the maintenance organization that is responsible for the “tools” used by the service technicians can use the Collaboration Manager Front-End to prepare the AR glasses to play the story. The member responsible for preparing the tools is referred to as the tools coordinator.

In the AR experience scenario, the tools coordinator does not need to establish a meeting and identify attendees using the Collaboration Manager Front-End, but does need to use the other features provided by the Collaboration Manager Front-End. The tools coordinator needs a link to any drivers necessary to playout the story and needs to download the story to each of the AR devices. The tools coordinator also needs to establish a relationship between the Collaboration Manager and the AR devices. The relationship is used to communicate any requests for additional information (e.g. from external sources) and/or assistance from a call center. Therefore, to the Collaboration Manager Front-End the tools coordinator is essentially establishing an ongoing, never ending meeting for all the AR devices used by the service team.

Ideally Tsunami would build a function in the VR headset device driver to “scan” the live data feeds for any alarms and other indications of a fault. When an alarm or fault is found, the driver software would change the data feed presentation in order to alert the support team member that is monitoring the virtual NOC.

The support team member also needs to establish a relationship between the Collaboration Manager and the VR headsets. The relationship is used to connect the live data feeds that are to be displayed on the Virtual NOCC to the VR headsets. communicate any requests for additional information (e.g. from external sources) and/or assistance from a call center. Therefore, to the Collaboration Manager Front-End the tools coordinator is essentially establishing an ongoing, never ending meeting for all the AR devices used by the service team.

The story and its associated access rights are stored under the author's account in Content Management System. The Content Management System is tasked with protecting the story from unauthorized access. In the virtual NOCC scenario, the support team member does not need to establish a meeting and identify attendees using the Collaboration Manager Front-End, but does need to use the other features provided by the Collaboration Manager Front-End. The support team member needs a link to any drivers necessary to playout the story and needs to download the story to each of the VR head.

The Asset Generator is a set of tools that allows a Tsunami artist to take raw data as input and create a visual representation of the data that can be displayed in a VR or AR environment. The raw data can be virtually any type of input from: 3D drawings to CAD files, 2D images to power point files, user analytics to real time stock quotes. The Artist decides if all or portions of the data should be used and how the data should be represented. The i Artist is empowered by the tool set offered in the Asset Generator.

The Content Manager is responsible for the storage and protection of the Assets. The Assets are VR and AR objects created by the Artists using the Asset Generator as well as stories created by users of the Story Builder.

Asset Generation Sub-System: Inputs: from anywhere it can: Word, Powerpoint, Videos, 3D objects etc. and turns them into interactive objects that can be displayed in AR/VR (HMD or flat screens). Outputs: based on scale, resolution, device attributes and connectivity requirements.

Story Builder Subsystem: Inputs: Environment for creating the story. Target environment can be physical and virtual. Assets to be used in story; Library content and external content (Word, Powerpoint, Videos, 3D objects etc). Output: Story; =Assets inside an environment displayed over a timeline. User Experience element for creation and editing.

CMS Database: Inputs: Manages The Library, Any asset: AR/VR Assets, MS Office files and other 2D files and Videos. Outputs: Assets filtered by license information.

Collaboration Manager Subsystem. Inputs: Stories from the Story Builder, Time/Place (Physical or virtual)/Participant information (contact information, authentication information, local vs. Geographically distributed). During the gathering/meeting gather and redistribute: Participant real time behavior, vector data, and shared real time media, analytics and session recording, and external content (Word, Powerpoint, Videos, 3D objects etc). Output: Story content, allowed participant contributions Included shared files, vector data and real time media; and gathering rules to the participants. Gathering invitation and reminders. Participant story distribution. Analytics and session recording (Where does it go). (Out-of-band access/security criteria).

Device Optimization Service Layer. Inputs: Story content and rules associated with the participant. Outputs: Analytics and session recording. Allowed participant contributions.

Rendering Engine Obfuscation Layer. Inputs: Story content to the participants. Participant real time behavior and movement. Outputs: Frames to the device display. Avatar manipulation

Real-time platform: The RTP This cross-platform engine is written in C++ with selectable DirectX and OpenGL renderers. Currently supported platforms are Windows (PC), iOS (iPhone/iPad), and Mac OS X. On current generation PC hardware, the engine is capable of rendering textured and lit scenes containing approximately 20 million polygons in real time at 30 FPS or higher. 3D wireframe geometry, materials, and lights can be exported from 3DS MAX and Lightwave 3D modeling/animation packages. Textures and 2D UI layouts are imported directly from Photoshop PSD files. Engine features include vertex and pixel shader effects, particle effects for explosions and smoke, cast shadows blended skeletal character animations with weighted skin deformation, collision detection, Lua scripting language of all entities, objects and properties.

### Technical Solutions to Technical Problems

Methods of this disclosure offer different technical solutions to important technical problems.

How to optimize limited data transmission resources in a network as the demand for data transmission to increasing numbers of user devices grows is one technical problem. Processes described herein provide technical solutions to this technical problem by sending different versions of virtual content depending on data transmission capabilities.

How to reduce processing costs is another technical problem. Processes described herein provide technical solutions to this technical problem by using different versions of virtual content depending on processing capabilities.

How to make data available to a user device under adverse circumstances experienced by that user device is another technical problem. Such adverse circumstances may include no or limited network connectivity for receiving virtual content, less-than-optimal user device capabilities (e.g., processing capacity below threshold, battery level below threshold, no three-dimensional display, no sensors, no permissions, limit of local memory), or other circumstances. Processes described herein provide technical solutions to this technical problem by using different versions of virtual content depending on the circumstances.

How to provide secure access to sensitive data by a particular user device is another technical problem. Processes described herein provide technical solutions to this technical problem by using different versions of virtual content depending on a security level of a data connection or user device.

How to provide user collaboration so more users can collaborate in new ways that enhance decision-making, reduce product development timelines, allow more users to participate, and provide other improvements is another technical problem. Processes described herein provide technical solutions to this technical problem by using different versions of virtual content for different collaborating users so each user can collaborate in some way instead of excluding users from collaboration if circumstances affecting that user would prohibit use of a particular version of the virtual content that could be provided to other users.

### Other Aspects

Each method of this disclosure can be used with virtual reality (VR), augmented reality (AR), and/or mixed reality (MR) technologies. Virtual environments and virtual content may be presented using VR technologies, AR technologies, and/or MR technologies.

Methods of this disclosure may be implemented by hardware, firmware or software. One or more non-transitory machine-readable media embodying program instructions that, when executed by one or more machines, cause the one or more machines to perform or implement operations comprising the steps of any of the methods or operations described herein are contemplated. As used herein, machine-readable media includes all forms of machine-readable media (e.g. non-volatile or volatile storage media, removable or non-removable media, integrated circuit media, magnetic storage media, optical storage media, or any other storage media) that may be patented under the laws of the jurisdiction in which this application is filed, but does not include machine-readable media that cannot be patented under the laws of the jurisdiction in which this application is filed. By way of example, machines may include one or more computing device(s), processor(s), controller(s), integrated circuit(s), chip(s), system(s) on a chip, server(s), programmable logic device(s), other circuitry, and/or other suitable means described herein or otherwise known in the art. One or more machines that are configured to perform the methods or operations comprising the steps of any methods described herein are contemplated. Systems that include one or more machines and the one or more non-transitory machine-readable media embodying program instructions that, when executed by the one or more machines, cause the one or more machines to perform or implement operations comprising the steps of any methods described herein are also contemplated. Systems comprising one or more modules that perform, are operable to perform, or adapted to perform different method steps/stages disclosed herein are also contemplated, where the modules are implemented using one or more machines listed herein or other suitable hardware.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps can be performed at any of the system components shown in the figures.

Processes described above and shown in the figures include steps that are performed at particular machines. In alternative embodiments, those steps may be performed by other machines (e.g., steps performed by a server may be performed by a user device if possible, and steps performed by the user device may be performed by the server if possible).

When two things (e.g., modules or other features) are “coupled to” each other, those two things may be directly connected together, or separated by one or more intervening things. Where no lines and intervening things connect two particular things, coupling of those things is contemplated in at least one embodiment unless otherwise stated. Where an output of one thing and an input of another thing are coupled to each other, information sent from the output is received by the input even if the data passes through one or more intermediate things. Different communication pathways and protocols may be used to transmit information disclosed herein. Information like data, instructions, commands, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

1. A method for determining values of conditions experienced by a user operating a user device, and using the values of the conditions to determine a value of a permission to apply to the user, the method comprising:
determining a value of a first condition experienced by the user operating the user device;
using the value of the first condition experienced by the user to determine a value of a first permission associated with the value of the first condition that can be applied to the user; and
applying the value of the first permission or another value of the first permission to the user.

2. The method of claim 1, wherein applying the value of the first permission or another value of the first permission to the user comprises:
allowing the user to perform only actions that are specified by the value of the first permission or another value of the first permission that is applied to the user.

3. The method of claim 1, wherein the value of the first condition experienced by the user is a level of connectivity available to the user, a value of a device input capability available to the user, a value of a device output capability available to the user, a value of a device setting capability available to the user, or a value of a processing capability available to the user.

4. The method of claim 3, wherein the value of the first condition experienced by the user is the level of connectivity available to the user, and wherein using the value of the first condition experienced by the user to determine the value of the first permission that can be applied to the user comprises:
comparing the level of connectivity available to the user to a first threshold level of connectivity;
if the level of connectivity available to the user is below the first threshold level of connectivity, determining that the value of the first permission is a first stored value of the first permission; and
if the level of connectivity available to the user is not below the first threshold level of connectivity, determining that the value of the first permission is a second stored value of the first permission that is different than the first stored value of the first permission.

5. The method of claim 3, wherein the value of the first condition experienced by the user is a value of a device input capability available to the user, a value of a device output capability available to the user, a value of a device setting capability available to the user, or a value of a processing capability available to the user, and wherein using the value of the first condition experienced by the user to determine the value of the first permission that can be applied to the user comprises:
determining that the value of the first permission is a stored value of the first permission that is associated with the value of the first condition.

6. The method of claim 3, wherein the value of the first permission specifies one or more available types of communication that the user can send to another user, one or more available types of communication that the user can receive from another user, a maximum level of quality for any virtual object that the user device can render, or one or more interactions with virtual content that are allowed for user.

7. The method of claim 6, wherein applying the value of the first permission or another value of the first permission to the user comprises:
allowing the user to generate or send only the one or more available types of communication that the user can send to another user,
allowing the user to receive the only one or more available types of communication that the user can receive from another user,
allowing the user device to receive a version of virtual object with a quality that is no greater than the maximum level of quality for any virtual object that the user device can render, or
allowing the user to interact with virtual content using only the one or more interactions with virtual content that are allowed for user.

8. The method of claim 1, the method comprising:
determining a value of a second condition experienced by the user;
using the value of the second condition experienced by the user to determine another value of the first permission that can be applied to the user;
selecting, from a group of permission values that includes the value of the first permission and the other value of the first permission, a permission value of to apply to the user; and
applying the selected permission value of the first permission to the user.

9. The method of claim 8, wherein applying the selected permission value comprises:
allowing the user to perform only actions that are specified by the selected permission value.

10. The method of claim 8, wherein the value of the first condition experienced by the user and the value of the second condition experienced by the user are different values from a group of condition values that includes two or more of a level of connectivity available to the user, a value of a device input capability available to the user, a value of a device output capability available to the user, a value of a device setting capability available to the user, or a value of a processing capability available to the user.

11. The method of claim 10,
wherein the value of the first condition experienced by the user is the level of connectivity available to the user,
wherein the value of the second condition experienced by the user is a value of a device input capability available to the user, a value of a device output capability available to the user, a value of a device setting capability available to the user, or a value of a processing capability available to the user,
wherein using the value of the first condition experienced by the user to determine the value of the first permission that can be applied to the user comprises
(i) comparing the level of connectivity available to the user to a first threshold level of connectivity,
(ii) if the level of connectivity available to the user is below the first threshold level of connectivity, determining that the value of the first permission is a first stored value of the first permission, and
(iii) if the level of connectivity available to the user is not below the first threshold level of connectivity, determining that the value of the first permission is a second stored value of the first permission that is different than the first stored value of the first permission, and
wherein using the value of the second condition experienced by the user to determine the other value of the first permission that can be applied to the user comprises:
determining that the other value of the first permission is a third stored value of the first permission that is associated with the value of the second condition.

12. The method of claim 11, wherein the selected permission value is either the value of the first permission or the other value of the first permission, and wherein the selecting a permission value to apply to the user comprises:
determining which of the value of the first permission and the other value of the first permission specifies the most is the most-limiting permission value; and
setting the selected permission value as the most-limiting permission value of the value of the first permission and the other value of the first permission.

13. The method of claim 10,
wherein the value of the first condition experienced by the user and the value of the second condition experienced by the user are different values from a group of condition values that includes two or more of a value of a device input capability available to the user, a value of a device output capability available to the user, a value of a device setting capability available to the user, or a value of a processing capability available to the user,
wherein using the value of the first condition experienced by the user to determine the value of the first permission that can be applied to the user comprises determining that the value of the first permission is a first stored value of the first permission that is associated with the value of the first condition, and
wherein using the value of the second condition experienced by the user to determine the other value of the first permission that can be applied to the user comprises determining that the other value of the first permission is a second stored value of the first permission that is associated with the value of the second condition.

14. The method of claim 13, wherein the selected permission value is either the value of the first permission or the other value of the first permission, and wherein the selecting a permission value to apply to the user comprises:
determining which of the value of the first permission and the other value of the first permission specifies the most is the most-limiting permission value; and
setting the selected permission value as the most-limiting permission value of the value of the first permission and the other value of the first permission.

15. The method of claim 1, the method comprising:
repeating the steps of claim 1 for another user instead of the user,
wherein the value of the first condition experienced by the user is different than the value of the first condition experienced by the other user,
wherein the value of the first permission applied to the user is different than the value of the first permission applied to the other user.

16. The method of claim 1, the method comprising:
repeating the steps of claim 1 for a second permission instead of the first permission.

17. The method of claim 1, wherein the user device operated by user is a virtual reality, an augmented reality, or a mixed reality user device.

18. A system for determining values of conditions experienced by a user, and using the values of the conditions to determine a value of a permission to apply to the user, wherein the system comprises one or more machines and one or more non-transitory machine-readable media storing instructions that are operable, when executed by the one or more machines, to cause the one or more machines to perform operations of claim 1.

19. One or more non-transitory machine-readable media embodying program instructions that, when executed by one or more machines, cause the one or more machines to implement the method of claim 1.
